(19) United States
(12) Patent Application Publication
(10) Pub. No.: US 2020/0367008 A1
(43) Pub. Date: Nov. 19, 2020

(54) SYSTEM AND METHOD FOR RENDERING VIRTUAL SOUND SOURCES

(71) Applicant: DTS, Inc., Calabasas, CA (US)

(72) Inventors: Martin Walsh, Scotts Valley, CA (US); Edward Stein, Soquel, CA (US)

(73) Assignee: DTS, Inc., Calabasas, CA (US)

(21) Appl. No.: 16/940,305

(22) Filed: Jul. 27, 2020

Related U.S. Application Data
(63) Continuation-in-part of application No. 16/875,859, filed on May 15, 2020.
(60) Provisional application No. 62/848,457, filed on May 15, 2019.

(51) Int. Cl. H04S 7/00; G06F 3/01; G02B 27/01; H04B 3/32; G06T 19/00

(52) U.S. Cl. CPC H04S 7/304; G06F 3/012; G02B 2027/0187; H04B 3/32; G06T 19/006; G02B 27/0179

(57) ABSTRACT

A system and method for accurately rendering a virtual sound source at a specified location is disclosed. The sound source is rendered through loudspeakers while visual content is rendered on the screen of a device (such as a tablet computing device or a mobile phone). Embodiments of the system and method estimate both the device pose and the listener pose and render the sound source through loudspeakers or headphones in accordance with the listener pose. The sound source is rendered to the listener such that the perceived location does not change if the device pose is changed, for instance by rotation or translation of the device.

### CROSS-REFERENCE TO RELATED APPLICATIONS

This application is a Continuation-in-Part of U.S. patent application Ser. No. 16/875,859, filed on May 15, 2020, and titled “AUDIO SOURCE LOCALIZATION ERROR COMPENSATION,” which is related and claims priority to U.S. Provisional Application No. 62/848,457, filed on May 15, 2019, and titled “AUDIO LOCALIZATION ERROR COMPENSATION FOR AUGMENTED REALITY DEVICES,” the contents of both which are herein incorporated by reference in their entirety.

### BACKGROUND

Sound (or audio) source localization is the process of identifying or estimating the location of a sound. This includes detecting the direction and distance of a sound source relative to a reference position, for instance a listener's position. Most human listeners are effective at sound source localization; in other words, most human beings are capable of accurately determining the location of a sound source in a three-dimensional (3D) environment.

Human listeners localize physical sound sources using various cues, for instance binaural cues such as time and level differences between the sounds arriving at the listener's ears. Human listeners likewise localize virtual sound sources using such cues; a virtual sound source is one which is not physically present but which is generated synthetically so that the audio signals presented to the listener's ears have cues intended to correspond to those of a physical sound source at a particular location. In order for a virtual sound source to be perceived as coming from a particular location, the acoustic signals presented at the listeners ears to render that source must have similar localization cues as a physical sound source at that location.

Accurate rendering of the location of virtual sound sources is essential for creating realistic immersive experiences in applications including virtual reality, augmented reality, and mixed reality. Virtual reality (VR) is a simulated audio and visual experience that can mimic or be completely different from the real world. VR involves rendering synthetic visual objects and virtual sound sources to the user. Augmented reality (AR) refers to an experience wherein real-world objects and environments are enhanced by synthetic information. Mixed reality (MR) is an experience of combined real and virtual worlds wherein real objects and virtual objects are simultaneously present and interactive.

If a VR/AR/MR experience does not render the locations of virtual sound sources such that they match what is visually displayed to the user, then the user's immersive experience will be disrupted, and the illusion of VR/AR/MR will be unconvincing. Inconsistency between the perceived visual and auditory locations of a sound source may compromise the fidelity of a VR/AR/MR experience since it is incongruous with general human perception of the physical world.

In VR, AR, and MR applications, elements of a virtual world are presented to a user through one or more perceptual rendering devices. For example, in VR the visual elements of a virtual world may be rendered through goggles worn by the user and the sound elements of the virtual world may be rendered through headphones worn by the user. Another way in which a user may experience elements of a virtual world in VR, AR, and MR applications is through a “magic window.” A magic window renders visual content to the user on a screen, for instance on a tablet or a smartphone. The user may view different elements of the virtual world by moving the magic window.

In this magic window framework, sounds from the virtual-world elements may be rendered to the user in different ways, such as through headphones worn by the user or through loudspeakers situated on the device being used as the magic window, in other words the tablet or smartphone. The visual rendering device acts as a seemingly magic “window” through which the listener can look into and hear a 3D scene. The visual rendering device acts as a viewport through which the user can see a 3D scene, and the audio rendering device provides sounds from the virtual world to the user.

The position and orientation of a rendering device in space is known as the device pose. In the magic window application, the pose of the viewport device must be determined in order to orient what the user perceives through the window. The magic window device pose can be estimated using a camera, position sensors, orientation sensors, or a combination of such components and sensors. In some cases, such sensors are incorporated in the magic window device. Once estimated, the device pose can be used to control what is perceptually rendered to the user, for instance, the visual scene displayed on the device screen.

One problem with magic window applications (and other similar applications) is that they often use the magic window device pose to determine not only the visual rendering to the user but also the sound rendering. In many implementations, it is assumed that the position and orientation of the magic window device is the same as the position and orientation of the listener's face and head, in other words that the device pose and the listener pose are the same. Typically, however, the magic window device is situated at a distance from the user's head. By way of example, a common scenario is where the magic window device is held at arm's length by the user. There can thus be a significant difference between the device pose and the listener pose, and hence a significant incongruity in the sound source localization. If a sound source is rendered to the listener based on the device pose instead of the listener pose, the sound source will not be localized by the user in way that is consistent with the virtual scene. This results in a perceptually inconsistent scene and detracts from the listener's immersive experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the virtual sound source rendering system and method disclosed herein take into account the listener's true head position for positional tracking and sound source rendering. Unlike embodiments of the system and method disclosed herein, prior approaches in VR/AR/MR applications render virtual sound sources based on the device pose. This results in errors in the locations of the rendered sounds as perceived by the listener. Embodiments of the system and method disclosed herein render the virtual sound sources based on the listener pose. This novel approach mitigates any rendering errors and enhances a user's VR/AR/MR experience. In some embodiments of the system and method disclosed herein, the listener pose is determined from an estimate of the device pose. In other embodiments of the system and method disclosed herein, the listener pose is determined based on sensors worn by the listener.

In some embodiments of the system and method the front “selfie” camera of the “magic window” device is used to determine the relative position and orientation of the listener's head. In some embodiments the estimated relative listener pose is then used in conjunction with the device pose to estimate the listener's position with respect to a reference point. This ensures that localization cues used to render virtual sound sources are correct for “magic window” applications, both for when the sound source is an object in the magic window's display and when the sound source is an object that is out of the magic window's frame of view but is still persistent and should still be rendered accurately to the user.

Embodiments include a method for accurately rendering the location of a virtual sound source. This includes determining a device pose of a visual rendering device and tracking a listener pose of a listener's head relative to the device pose. The listener pose is used instead of the device pose to accurately render the audio object from the listener's perspective. In some embodiments, the audio is rendered using loudspeakers situated on the visual rendering device, i.e. the magic window device. In some embodiments, the audio is rendered using headphones. In some embodiments, the audio is rendered using a multichannel loudspeaker system.

Embodiments of the system and method have several advantages. One advantage is an enhanced audio experience for users of augmented reality devices. Another advantage is augmented three-dimensional (3D) audio rendering for both headphones and speakers.

It should be noted that alternative embodiments are possible, and steps and elements discussed herein may be changed, added, or eliminated, depending on the particular embodiment. These alternative embodiments include alternative steps and alternative elements that may be used, and structural changes that may be made, without departing from the scope of the invention.

### BRIEF DESCRIPTION OF THE DRAWINGS

FIG. 1 depicts a coordinate system with six degrees of freedom in a 3-dimensional space.

FIG. 2 illustrates a scenario where the listener pose and rendering device pose are essentially the same.

FIG. 3 illustrates a magic window VR/AR/MR scenario where the listener pose and rendering device pose are different.

FIG. 4A illustrates embodiments of the virtual sound source rendering system and method implemented in a magic window VR/AR/MR scenario.

FIG. 4B illustrates a magic window VR/AR/MR scenario with a translation change for the device pose while the listener pose remains unchanged with respect to FIG. 4A.

FIG. 5A illustrates embodiments of the virtual sound source rendering system and method implemented in a magic window VR/AR/MR scenario.

FIG. 5B illustrates a magic window VR/AR/MR scenario with a rotation change for the listener pose and a compound change for the device pose with respect to FIG. 5A.

FIG. 6 is a block diagram of embodiments of the virtual sound source rendering system disclosed herein.

FIG. 7 is a flow diagram illustrating the general operation of embodiments of the virtual sound source rendering method disclosed herein.

### DETAILED DESCRIPTION

Virtual reality, augmented reality, and mixed reality (VR/AR/MR) experiences consist of visual objects and sound sources that are rendered to a user. Visual objects are rendered to the user via a visual rendering device, for instance goggles, glasses, or a “magic window” screen on a computer tablet, smartphone, or other portable device. Sound sources are rendered to the user via an audio rendering device, for instance headphones or earbuds worn by the user or loudspeakers incorporated in the portable “magic window” device. For a VR/AR/MR experience to be perceptually convincing, virtual visual objects and virtual sound sources must be rendered in a way that is consistent with physical real-world experiences. For instance, a stationary virtual sound source must be rendered such that the location perceived by the user remains fixed even if the user or the device moves. VR/AR/MR devices often include position and orientation sensors which can be used to estimate the device's position and orientation (pose). Current VR/AR/MR applications commonly render virtual sound sources with respect to the device pose, which to the user can result in apparent motion of a stationary virtual sound source. Embodiments of the system and method disclosed herein avoid such rendering errors by estimating the listener pose and using the listener pose to render virtual sound sources.

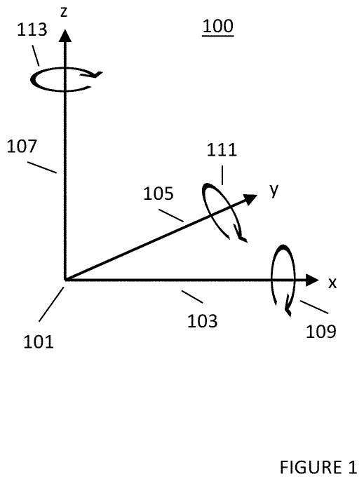

FIG. 1 illustrates a coordinate system 100 with six degrees of freedom in a three-dimensional space. The position of an object in the coordinate system 100 is described with respect to an origin 101 by rectangular coordinates x, y, and z, which may be expressed mathematically as a triplet (x, y, z) or as a vector

$$[ \begin{matrix}x \\ y \\ z\end{matrix} ] .$$

The x coordinate denotes translation along the x axis 103 with respect to the origin 101, they coordinate denotes translation along the y axis 105 with respect to the origin 101, and the z coordinate denotes translation along the z axis 107 with respect to the origin 101. In some embodiments, the x axis corresponds to forward/backward translation, the y axis corresponds to left/right translation, and the z axis corresponds to up/down translation. In some embodiments, forward/backward translation is referred to as surge, left/right translation is referred to as sway, and up/down translation is referred to as heave. The orientation of an object in the coordinate system 100 is described using three angles

$$[ \begin{matrix}γ \\ β \\ α\end{matrix} ]$$

respectively indicating rotation 109 around the x axis, rotation 111 around the y axis, and rotation 113 around the z axis. In some embodiments, these angles are respectively referred to as roll, pitch, and yaw. An object's position and orientation in the coordinate system 100 is referred to as its pose. Those of ordinary skill in the art will understand that coordinate systems other than the one depicted in FIG. 1 and described above may be used in the virtual sound source rendering system and method disclosed herein and are within the scope of the invention.

In virtual reality, augmented reality, and mixed reality (VR/AR/MR) applications, a coordinate system such as the one in FIG. 1 is established. In order to render a VR/AR/MR experience, various aspects of the VR/AR/MR experience are attributed with corresponding poses within the coordinate system 100. In some embodiments, the user is attributed with a pose. In some embodiments, the visual rendering device is attributed with a pose. In some embodiments, the audio rendering device is attributed with a pose. In some embodiments, virtual objects are attributed with poses. In several embodiments, the VR/AR/MR rendering system is configured to use one or more of such attributed poses to render the VR/AR/MR experience to the user. Because some embodiments of the invention relate to a device user's perception of sound, the device user in some of these embodiments is referred to as the listener. In various application scenarios, the pose of the VR/AR/MR device changes during the application. In various application scenarios, the pose of the listener changes. In some embodiments a pose change will either correspond to a translation change, an orientation change, or a compound change consisting of a combination of a translation change and an orientation change.

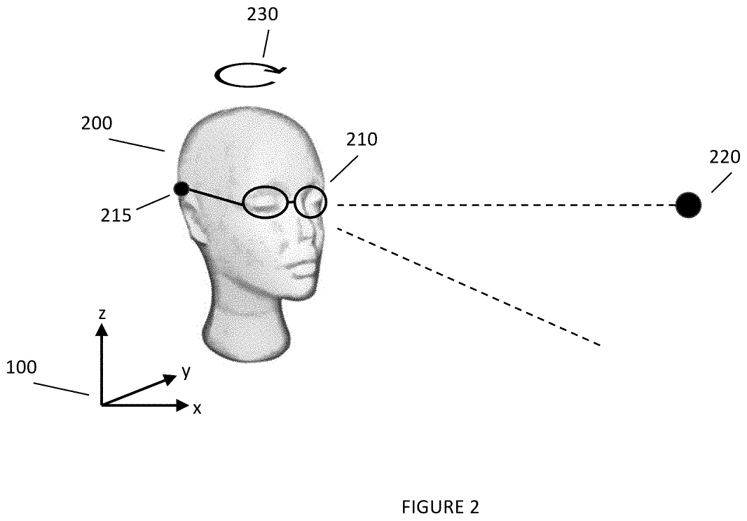

FIG. 2 illustrates the rendering of a sound source when the listener pose and device pose are essentially the same. As shown in FIG. 2, a listener 200 is wearing a visual rendering device 210 on which is rendered a virtual visual scene. The visual rendering device 210 may be any one of several types of visual rendering device including virtual reality goggles or augmented reality glasses. The virtual audio scene is rendered to the user via an audio rendering device 215. It should be noted that in FIG. 2 the audio rendering device 215 is depicted as a loudspeaker for rendering audio to the listener 200, and that the loudspeaker is incorporated into the stem of the visual rendering device 210. Although for pedagogical purposes the audio rendering device 215 is shown as a loudspeaker incorporated into the visual rendering device 210 in FIG. 2, the audio rendering device can be any one of a variety of different types of devices including headphones, earbuds, loudspeakers that are incorporated in the visual rendering device 210, and loudspeakers that are part of a surround sound system. Moreover, FIG. 2 only illustrates a single loudspeaker on the near ear of the listener 200 and loudspeaker directed to the listener's ear on the far side of the listener's head is not explicitly shown. But those of ordinary skill in the art will appreciate that a virtual sound source 220 is rendered to both of the listener's ears in VR/AR/MR applications. The virtual sound source 220 is situated at a particular point in space, in other words at a particular location in the coordinate system 101. The virtual sound source 220 is rendered to the listener 200 using the audio rendering device 215 based on the pose of the visual rendering device 210. Moreover, as one of ordinary skill in the art would understand, when loudspeakers are used crosstalk cancellation based at least in part on the listener pose may be used to render the virtual sound source 220 to the listener.

If the virtual sound source 220 is stationary, it should be rendered such that it is perceived by the listener 200 as being at the same location with respect to the origin of the coordinate system 100 independent of the listener pose. In other words, the virtual sound source 220 should not be perceived to move as the listener 200 moves. The virtual sound source 220 is rendered to the listener 200 via transducers in the audio rendering device 215 that move with the listener 200, however. Thus, in order to render the virtual sound source 220 as stationary with respect to the coordinate-system origin 101 of the coordinate system 100 as the listener pose changes, the virtual sound source rendering via audio rendering device 215 must compensate for the listener pose. By way of example, if the listener 200 rotates (as indicated by the rotational arrow 230), in order to remain stationary with respect to the coordinate-system origin 101 the virtual sound source 220 must be rendered to the listener 200 with an opposite rotational change that compensates for the listener pose rotation. For instance, if a stationary virtual sound source 220 is initially directly in front of the listener 200 at azimuth angle 0 and the listener 200 rotates by an azimuth angle α (yaw), the virtual sound source 220 must be rendered at an angle—α with respect to the listener 200 in order to be perceived by the rotated listener 200 as having remained at the same location in the virtual coordinate system.

As discussed above with reference to FIG. 2, for accurate positional rendering of virtual sound sources it is necessary to render the sound sources with respect to the listener pose. In typical embodiments, devices for AR, VR, and MR applications include sensors for estimating and tracking the device pose. For the example of FIG. 2, the device pose and the listener pose are essentially the same since the visual rendering device 210 is worn on the listener's head. In this example, the device pose can be reliably used as an estimate of the listener pose for rendering virtual sound sources 220.

In the system of FIG. 2, the listener 200 wears both the visual rendering device 210 and the audio rendering device 215 for the VR/AR/MR experience such that the listener pose and the device pose are essentially the same. In some cases, however, the visual rendering device 210 may be a handheld device such as a tablet computer or a mobile phone. The screen on the device provides a view of the VR/AR/MR world. In such “magic window” applications, the audio may in some cases be rendered using loudspeakers on the handheld device (in other words the audio rendering device 215 is handheld device loudspeakers). In other cases, it may be rendered via headphones worn by the user (in other words the audio rendering device 215 is headphones). In other cases, it may be rendered using loudspeakers that are distinct from the handheld device (in other words the audio rendering device 215 is separate loudspeakers). In light of these various examples, the listener pose, the visual rendering device 210 pose, and the audio rendering device 215 pose are most generally distinct from each other. In some cases, however, one or more of the poses are equivalent.

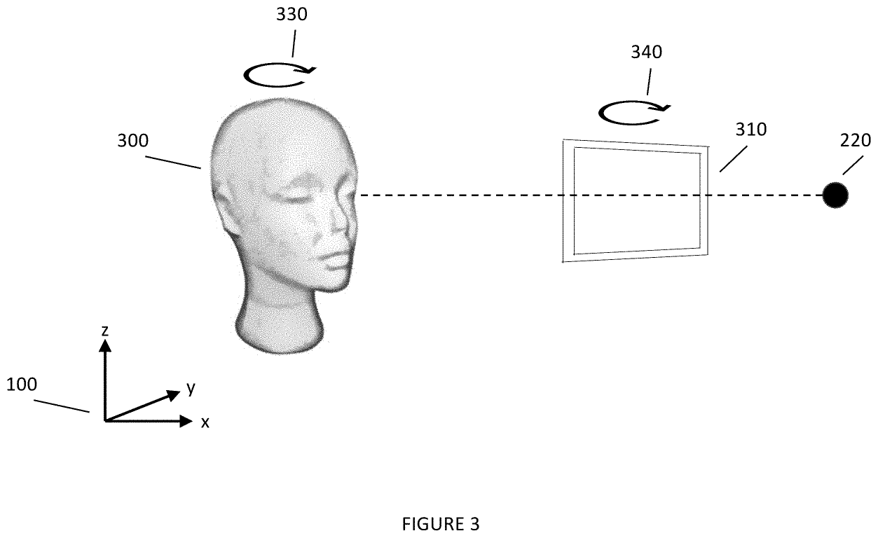

FIG. 3 depicts a magic window VR/AR/MR application scenario where the listener pose and rendering device pose are different. A user 300, a magic window device 310, and the virtual sound source 220 have respective poses in the coordinate system 100. For the purposes of this description but without loss of generality, the virtual sound source 220 is considered stationary. Sometimes the user 300 undergoes a pose change in the coordinate system 100, for instance a rotation 330. Other times the user 300 undergoes pose changes other than the rotation 330, for instance translations along the x, y, or z axis of the coordinate system 100 or orientation changes different from the depicted rotation. Sometimes the magic window device 310 undergoes a pose change in the coordinate system, for instance a rotation 340. Other times the magic window device 310 undergoes pose changes other than the rotation 340, for instance translations along the x, y, or z axis of the coordinate system 100 or orientation changes different from the depicted rotation. As previously explained, to render the virtual sound source 220 as stationary to the user, the device pose and the user pose must be estimated and accounted for in the audio rendering process.

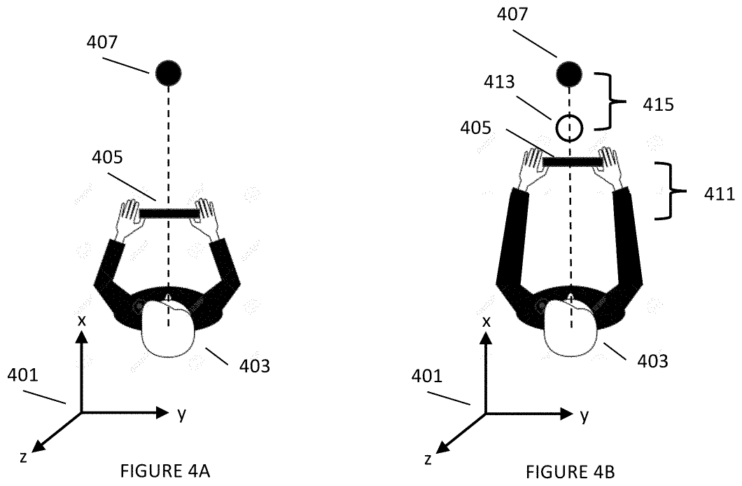

FIG. 4A illustrates embodiments of the virtual sound source rendering system and method implemented in a magic window VR/AR/MR application and a corresponding coordinate system 401. As shown in FIG. 4A, a listener 403 is illustrated holding a portable rendering device 405, for instance a tablet computer or a smartphone. A virtual sound source 407 is rendered to the listener 403 by the portable rendering device 405.

FIG. 4B illustrates the listener 403 and the portable rendering device 405 in the coordinate system 401 after a translation change 411 of the device pose with respect to the device pose shown in FIG. 4A. Note that the listener pose remains the same as in FIG. 4A. Because the listener 403 has not moved with respect to the virtual sound source 407 in the coordinate system 401, the virtual sound source 407 should be rendered unchanged to the listener 403. However, if the virtual sound source 407 rendering is based on the device pose, the virtual sound source 407 will be rendered as louder to the listener 403 with respect to the rendering in FIG. 4A since the device pose is closer to the virtual sound source 407 than in FIG. 4A. For example, the increased loudness of the virtual sound source 407 rendered based on the device pose will be perceived by the listener 403 as the sound being at a closer position (such as at position 413). If the virtual sound source 407 is rendered based on the device pose without considering the listener pose, moving the portable rendering device 405 closer to the virtual sound source 407 by translation 411 will be experienced by the listener 403 as the virtual sound source 407 moving closer to the listener 403, for example by translation 413.

The example illustrated in FIG. 4A and FIG. 4B can be considered mathematically as follows. As will be understood by those of ordinary skill in the art, the pose representations and transformations set forth below may use different coordinate systems or formulations (such as quaternions) from those set forth herein. Referring to FIG. 4A, the pose of the listener 403 can be expressed as (x_{L}, y_{L}, z_{L}), the pose of the portable rendering device 405 can be expressed as (x_{D}, y_{D}, z_{D}), and the location of the virtual sound source 407 can be expressed as (x_{S}, y_{S}, z_{S}). Without loss of generality, the vertical axis in the coordinate system 401 can be defined as the x axis and the example can be simplified by establishing that the y and z coordinates are equivalent between the various poses, specifically y_{L}=y_{D}=y_{S} and z_{L}=z_{D}=z_{S}. Furthermore, the orientation angles for all poses in this example are assumed to be zero; the orientation angles are therefore omitted from the pose notation. With respect to the listener 403, the virtual sound source 407 is at position (x_{S}−x_{L}, 0, 0). As will be understood by those of ordinary skill in the art, the virtual sound source 407 should be rendered to the listener 403 in accordance with its position relative to the listener 403, in particular with spatial cues corresponding to its directional position with respect to the listener 403 and with a loudness level corresponding to its distance from the listener 403. Considering the effect of the translation 411 of the rendering device in FIG. 4B on the various pose coordinates, the listener 403 remains at pose (x_{L}, y_{L}, z_{L}), the device 405 has undergone a translation to pose (x_{D}, +Δ, y_{D}, z_{D}), and the virtual sound source 407 remains at (x_{S}, y_{S}, z_{S}). With respect to the listener 403, the virtual sound source 407 remains at the relative position (x_{S}−x_{L}, 0, 0) and thus its rendering to the listener should remain unchanged. However, in some VR/AR/MR applications, the virtual sound source 407 is rendered to the listener 403 based on the pose of the device 405 without consideration of the pose of the listener 403. In such applications, the virtual sound source 407 is rendered to the listener 403 in accordance with the relative position of the virtual sound source 407 to the device 405, which is (x_{S}−x_{D}, 0, 0) in the example configuration of FIG. 4A and (x_{S}−x_{D}−Δ, 0, 0) in the example configuration of FIG. 4B. Since the relative distance between the device 405 and the virtual sound source 407 is smaller in FIG. 4B than in FIG. 4A, the virtual sound source 407 will be rendered at a higher loudness level to the listener 403 in the FIG. 4B example, which is erroneous in that the loudness level of the virtual sound source 407 should not change between the configurations of FIG. 4A and FIG. 4B since the relative distance between the listener 403 and the virtual sound source 407 has not changed between the two configurations. Embodiments of the system and method disclosed herein avoid such rendering errors by determining the listener pose and rendering virtual sound sources with respect to the listener pose instead of the device pose.

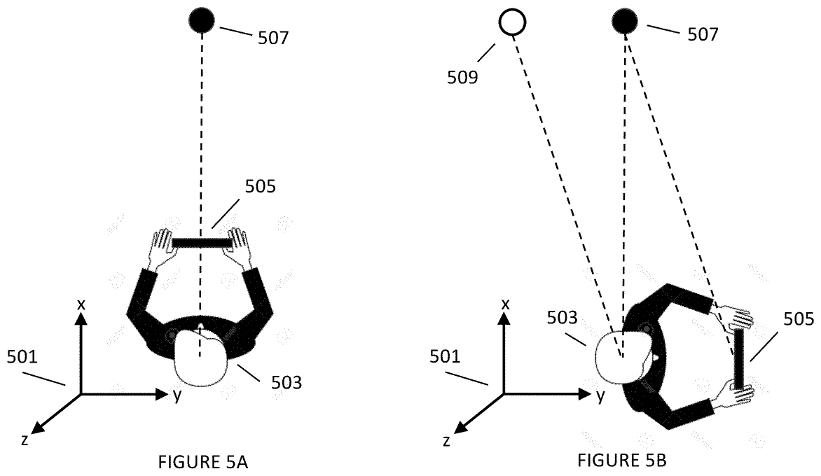

FIG. 5A illustrates embodiments of the virtual sound source rendering system and method implemented in a magic window VR/AR/MR application with a coordinate system 501. A listener 503 is illustrated holding a magic window device 505, for instance a tablet computer or a smartphone. The virtual sound source 507 is rendered to the listener 503 by the magic window device 505.

FIG. 5B illustrates the listener 503 and the magic window device 505 in the coordinate system 501 after the listener 503 has rotated 90 degrees while holding the magic window device 505. The user pose has changed by a 90-degree rotation with respect to the user pose in FIG. 5A. The device pose has changed by a 90-degree rotation and a translation with respect to the device pose in FIG. 5A. For the virtual sound source 507 to maintain the same perceived location in the coordinate system 501 after the user pose has changed by a 90-degree rotation, the virtual sound source 507 should be rendered to the left of the user. However, if the virtual sound source 507 is rendered to the listener 503 based on its location in the coordinate system 501 with respect to the device pose, it will be perceived at location 509.

The example illustrated in FIG. 5A and FIG. 5B can be considered mathematically as follows. As will be understood by those of ordinary skill in the art, the pose representations and transformations set forth below may use different coordinate systems or formulations (such as quaternions) from those set forth herein. Referring to FIG. 5A, the pose of the listener 503 can be expressed as (x_{L}, y_{L}, z_{L}, y_{L}, β_{L}, α_{L}), the pose of the portable rendering device 505 can be expressed as (x_{D}, y_{D}, z_{D}, y_{D}, β_{D}, α_{D}), and the location of the virtual sound source 507 can be expressed as (x_{S}, y_{S}, z_{S}), where the orientation angles have been included in the listener pose coordinates and device pose coordinates. Without loss of generality, the vertical axis in the coordinate system 501 is defined as the x axis, the horizontal axis is defined as the y axis, and the axis perpendicular to the page is defined as the z axis. With respect to the listener 503, the virtual sound source 507 is at position (x₅−x_{L}, 0, 0). As will be understood by those of ordinary skill in the art, the virtual sound source 507 should be rendered to the listener 503 in accordance with its position relative to the listener 503, in particular with spatial cues corresponding to its directional position with respect to the listener 503 and with a loudness level corresponding to its distance from the listener 503. Considering the effect on the various pose coordinates of the 90-degree counterclockwise rotation around the z axis (yaw) of the listener between FIG. 5A and FIG. 5B, the listener 503 is at pose (x_{L}, y_{L}, z_{L}, γ_{L}, β_{L}, α_{L}+90) in FIG. 5B, the device 505 is at pose (x_{D}−Δ, y_{D}+Δ, z_{D}, γ_{L}, β_{L}, α_{L}+90) where Δ=x_{D}−x_{L}, and the virtual sound source 507 is at the same location (x_{S}, y_{S}, z_{S}). In this example, the distance Δ between the device and listener remains the same through the rotation. With respect to the listener 503, the virtual sound source 507 remains at the relative position (x_{S}−x_{L}, 0, 0); accounting for the rotation, it should be rendered at an azimuth angle of −90 degrees and at the same distance x_{S}−x_{L} as in the configuration of FIG. 5A in order to be rendered at a stationary location in the coordinate system 501 as perceived by the listener. However, in some VR/AR/MR applications, the virtual sound source 507 is rendered to the listener 503 based on the pose of the device 505 without consideration of the pose of the listener 503. In such applications, the virtual sound source 507 is rendered to the listener 503 in accordance with the relative position of the virtual sound source 507 to the device 505, which is (x_{S}−x_{D}, 0, 0) in the example configuration of FIG. 5A and (x_{S}, −Δ, 0) in the example configuration of FIG. 5B.

The listener then perceives an erroneously positioned virtual sound source 509. Since the relative distance between the device 505 and the virtual sound source 507 is larger in FIG. 5B than in FIG. 5A, the virtual sound source 507 will be rendered at a lower loudness level to the listener 503 in the FIG. 5B example, which is erroneous in that the loudness level of the virtual sound source 507 should not change between the configurations of FIG. 5A and FIG. 5B since the relative distance between the listener 503 and the virtual sound source 507 has not changed between the two configurations. Furthermore, the virtual sound source is rendered at a location (x_{S}, −Δ, 0) with respect to the listener 503 in FIG. 5B, such that through the rotation the virtual sound source will have seemed to move from a position of (x_{S}, y_{S}, z_{S}) in the coordinate system 501 in the configuration of FIG. 5A to a position of (x_{S}, y_{S}−Δ, z_{S}) in the coordinate system 501 in the configuration of FIG. 5B, rather than remaining stationary. Embodiments of the system and method disclosed herein avoid such rendering errors by determining the listener pose and rendering virtual sound sources with respect to the listener pose instead of the device pose.

FIGS. 4A, 4B, 5A, and 5B depict examples wherein rendering a virtual sound source (407, 507) to a listener based on the device pose results in erroneous positioning of the virtual sound source (407, 507) in the VR/AR/MR coordinate system. Those of ordinary skill in the art will understand that the examples are representative and that such rendering errors would occur in scenarios other than those depicted.

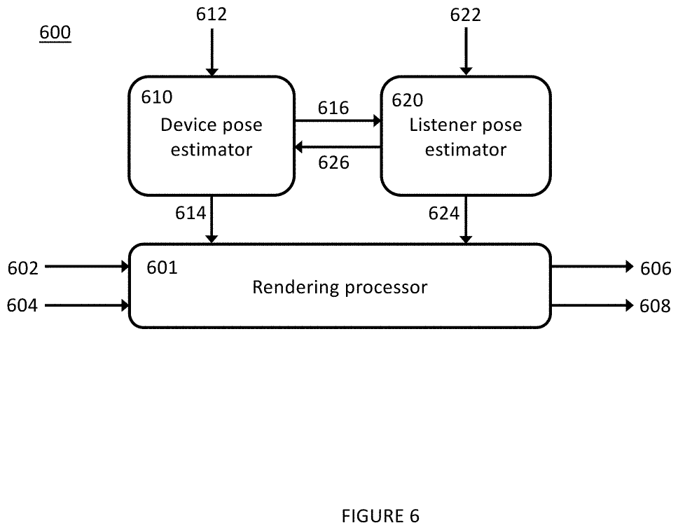

FIG. 6 is a block diagram of embodiments of the virtual sound source rendering system 600 disclosed herein for a VR/AR/MR device. The virtual sound source rendering system 600 includes a rendering processor 601. The rendering processor 601 receives input sound sources on line 602 and input visual objects on line 604. The rendering processor 601 renders the received input sound sources 602, combines the rendered sound sources, and provides an aggregate output sound for a user or listener on line 606. The rendering processor 601 also renders the received input visual objects 604, combines the rendered visual objects, and provides an aggregate output visual scene for the user or listener on line 608.

The virtual sound source rendering system 600 also includes a device pose estimator 610 and a user pose estimator 620. The rendering processor 601 receives an estimate of the device pose on line 614 from the device pose estimator 610. In addition, the rendering processor 601 receives an estimate of the user pose on line 624 from the user pose estimator 620.

In some embodiments the device pose estimator 610 in the virtual sound source rendering system 600 of FIG. 6 receives input on line 612. By way of example and not limitation, this input includes input from orientation sensors, cameras, and other types of sensing devices. In some embodiments, the device pose estimator 610 receives input on line 626 from the user pose estimator 620. The device pose estimator 610 derives an estimate of the device pose and provides that estimate to the rendering processor 601 on line 614. In some embodiments the device pose estimator 610 provides information about the device pose to the user pose estimator 620 on line 616.

In some embodiments the user pose estimator 620 in the virtual sound source rendering system 600 of FIG. 6 receives input on line 622. By way of example and not limitation, this input includes input from orientation sensors, cameras, and other types of sensing devices. In some embodiments, the user pose estimator 620 receives input from sensors worn by the user or listener. For example, the user may be wearing sensors in a wearable pose tracking device or pose detection device worn by the user. In some embodiments the user pose estimator 620 receives input on line 616 from the device pose estimator 610. The user pose estimator 620 derives an estimate of the user pose and provides that estimate to the rendering processor 600 on line 624. In some embodiments the user pose estimator 620 provides information about the user pose to the device pose estimator 610 on line 626.

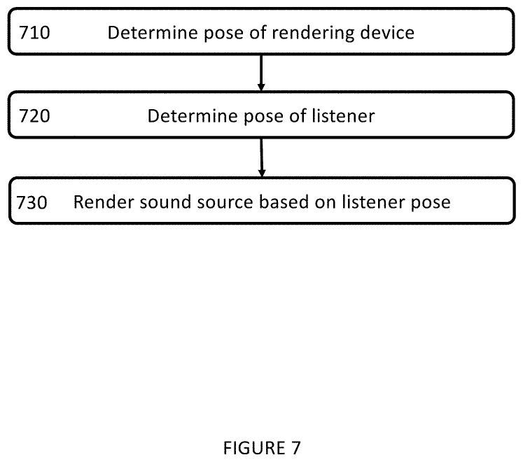

FIG. 7 is a flow diagram illustrating the general operation of embodiments of the virtual sound source rendering method disclosed herein. The operation begins by determining a device pose of the display or rendering device (box 710). In some embodiments the device pose is determined using positional and orientation sensors located on the rendering device. Next, the method determines or estimates a pose of the user (box 720), in particular of the user's head. In some embodiments this user pose is determined using head pose estimation techniques. In some embodiments one or more images from a user-facing camera on the rendering device are used to determine the head pose. In some embodiments the user pose is estimated from the device pose based on an assumption that the user is holding the device at arm's length in a certain orientation. In some embodiments the user pose is first determined relative to the device pose such that the user pose with respect to the origin is determined by combining the device pose relative to the origin with the user pose relative to the device.

The operation continues by rendering the virtual sound source to the user based on the user pose (box 730). The virtual sound source is rendered with the correct location by basing the rendering on the user pose. Previous approaches in VR/AR/MR applications render virtual sound sources based on the device pose, resulting in errors in the locations of the rendered sounds as perceived by the listener. Embodiments of the system and method disclosed herein can be incorporated in such approaches to correct the rendering errors.

### Alternate Embodiments and Exemplary Operating Environment

Many other variations than those described herein will be apparent from this document. For example, depending on the embodiment, certain acts, events, or functions of any of the methods and algorithms described herein can be performed in a different sequence, can be added, merged, or left out altogether (such that not all described acts or events are necessary for the practice of the methods and algorithms). Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines and computing systems that can function together.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The various illustrative logical blocks and modules described in connection with the embodiments disclosed herein can be implemented or performed by a machine, such as a general-purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Embodiments of the virtual sound source rendering system and method described herein are operational within numerous types of general purpose or special purpose computing system environments or configurations. In general, a computing environment can include any type of computer system, including, but not limited to, a computer system based on one or more microprocessors, a mainframe computer, a digital signal processor, a portable computing device, a personal organizer, a device controller, a computational engine within an appliance, a mobile phone, a desktop computer, a mobile computer, a tablet computer, a smartphone, and appliances with an embedded computer, to name a few.

Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the computing devices will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

The process actions or operations of a method, process, or algorithm described in connection with the embodiments disclosed herein can be embodied directly in hardware, in a software module executed by a processor, or in any combination of the two. The software module can be contained in computer-readable media that can be accessed by a computing device. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

Computer storage media includes, but is not limited to, computer or machine readable media or storage devices such as Blu-ray discs (BD), digital versatile discs (DVDs), compact discs (CDs), floppy disks, tape drives, hard drives, optical drives, solid state memory devices, RAM memory, ROM memory, EPROM memory, EEPROM memory, flash memory or other memory technology, magnetic cassettes, magnetic tapes, magnetic disk storage, or other magnetic storage devices, or any other device which can be used to store the desired information and which can be accessed by one or more computing devices.

A software module can reside in the RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an application specific integrated circuit (ASIC). The ASIC can reside in a user terminal. Alternatively, the processor and the storage medium can reside as discrete components in a user terminal.

The phrase “non-transitory” as used in this document means “enduring or long-lived”. The phrase “non-transitory computer-readable media” includes any and all computer-readable media, with the sole exception of a transitory, propagating signal. This includes, by way of example and not limitation, non-transitory computer-readable media such as register memory, processor cache and random-access memory (RAM).

The phrase “audio signal” is a signal that is representative of a physical sound.

Retention of information such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

Further, one or any combination of software, programs, computer program products that embody some or all of the various embodiments of the virtual sound source rendering system and method described herein, or portions thereof, may be stored, received, transmitted, or read from any desired combination of computer or machine readable media or storage devices and communication media in the form of computer executable instructions or other data structures.

Embodiments of the virtual sound source rendering system and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the scope of the disclosure. As will be recognized, certain embodiments of the inventions described herein can be embodied within a form that does not provide all of the features and benefits set forth herein, as some features can be used or practiced separately from others.

What is claimed is:

1. A method for rendering a virtual sound source, comprising:
determining a listener pose of a listener's head; and
using the listener pose to render the virtual sound source on an audio rendering device.

2. The method of claim 1, wherein determining the listener pose of a listener's head further comprises:
determining a device pose of the audio rendering device; and
determining the listener pose relative to the device pose.

3. The method of claim 1, wherein the audio rendering device is also a visual rendering device.

4. The method of claim 1, wherein determining the listener pose of a listener's head further comprises:
determining a device pose of the audio rendering device; and
determining the listener pose from an estimate of the device pose.

5. The method of claim 4, wherein the audio rendering device is also a magic window device and further comprising determining the estimate of the device pose using a camera on the magic window device to determine a relative position and orientation of the listener's head to obtain an estimated relative listener pose.

6. The method of claim 5, further comprising estimating the listener's position relative to a reference point using the estimated relative listener pose and the device pose.

7. A method for rendering a virtual sound source, comprising:
determining a device pose of a visual rendering device;
determining a listener pose of a listener's head relative to the device pose of the visual rendering device; and
using the listener pose to render the virtual sound source on an audio rendering device.

8. The method of claim 7, wherein the audio rendering device includes headphones.

9. The method of claim 7, wherein the audio rendering device includes loudspeakers incorporated in the visual rendering device.

10. The method of claim 9, further comprising rendering the virtual sound source to the listener using crosstalk cancellation based at least in part on the listener pose.

11. The method of claim 7, wherein moving the audio rendering device does not affect the location of the virtual sound source as perceived by the listener.

12. The method of claim 7, wherein moving the visual rendering device does not affect the location of the virtual sound source as perceived by the listener.

13. The method of claim 7, further comprising determining the listener pose using a camera located on the visual rendering device.

14. The method of claim 7, wherein determining the listener pose further comprises assuming a configuration of the listener and the visual rendering device.

15. The method of claim 7, further comprising determining the listener pose using a wearable pose tracking device worn by the listener.

16. A method for rendering a virtual sound source on an audio rendering device, comprising:
determining a device pose of the audio rendering device used to render the virtual sound source and reporting the device pose to an audio rendering processor contained on the audio rendering device;
determining a listener pose of a listener's head and reporting the listener pose to the audio rendering processor; and
rendering the virtual sound source on the audio rendering device using the listener pose such that the virtual sound source is rendered from a point of view of the listener.

17. The method of claim 16, wherein the audio rendering device is contained on a visual rendering device.

18. The method of claim 17, further comprising keeping the loudness of the virtual sound source the same whenever the visual rendering device is moved with respect to the virtual sound source.

19. The method of claim 16, further comprising rendering the virtual sound source at least in part based on the listener pose.

20. The method of claim 16, wherein the audio rendering device is a mobile phone.
